(19) United States
(12) Patent Application Publication
(10) Pub. No.: US 2018/0038552 A1
(43) Pub. Date: Feb. 8, 2018

(54) DEVICE FOR SUPPLYING PRESSURISED FLUID AND CORRESPONDING FLUID TRANSFER MEMBER

(71) Applicant: L'Air Liquide, Société Anonyme pour I'Etude et I'Exploitation des Procédés Georges Claude, Paris (FR)

(72) Inventor: Antoine FRENAL, Ezanville (FR)

(21) Appl. No.: 15/555,358

(22) PCT Filed: Mar. 2, 2016
(86) PCT No.: PCT/FR2016/050466

§ 371 Date: Sep. 1, 2017

(30) Foreign Application Priority Data
Mar. 4, 2015 (FR) 1551812

(51) Int. Cl. F17C 13/04; F17C 7/00

(52) U.S. Cl. CPC F17C 13/04; F17C 7/00; F17C 2201/058; F17C 2203/0617; F17C 2205/0329; F17C 2205/0335; F17C 2205/0373; F17C 2205/0385; F17C 2205/0394; F17C 2223/0123; F17C 2223/036; F17C 2270/0745

(57) ABSTRACT

A device for supplying pressurized fluid, including at least one isolation shutter, the a fluid transfer member separate from the valve and from the tank and includes an internal circuit for transferring fluid, the transfer member and said first valve including coupling members that form a quick-connection system, in the position in which the transfer member is connected to the first valve, the internal circuit of the transfer member being fluidically connected to the internal circuit of the first valve, the device including a stop that is sensitive to the pressure in the internal circuits in order to lock the coupling members in the connected position when said pressure is greater than a given threshold, the stop being able to move between a first position not locking the coupling members and a second position locking the coupling members.

### CROSS REFERENCE TO RELATED APPLICATIONS

This application is a 371 of International PCT Application PCT/FR2016/050466, filed Mar. 2, 2016, which claims priority to French Patent Application No. 1551812, filed Mar. 4, 2015, the entire contents of which are incorporated herein by reference.

### BACKGROUND

The present invention relates to a device for supplying pressurized fluid and to a corresponding fluid transfer member.

### SUMMARY

The invention relates more particularly to a device for supplying pressurized fluid, notably pressurized gas, comprising a tank of pressurized fluid provided with an orifice in which a first valve is fixed that houses an internal fluid circuit provided with at least one isolation shutter, the device comprising a fluid transfer member that forms a separate physical entity from the valve and from the tank, the transfer member comprising an internal circuit for transferring pressurized fluid, the transfer member and said first valve comprising respective coupling members that form a quick-connection system for removably connecting the transfer member to the valve, in the position in which the transfer member is connected to the first valve, the internal circuit of the transfer member being fluidically connected to the internal circuit of the first valve, the device comprising a stop that is sensitive to the pressure in at least one of the internal circuits in order to lock the coupling members in the connected position and to prevent the disconnection of the transfer member from the first valve when said pressure is greater than a given threshold.

The invention relates in particular to a device for distributing fluid, notably pressurized gas, of a modular type.

Examples of various modular fluid distribution devices are illustrated in the documents FR2892799A1, FR2979687A1 or FR2970313A1.

When these devices use high-pressure fluid (for example at a pressure of 200 bar or above), the safety conditions have to be enhanced so as not to expose the user to high pressures in the event of improper handling.

The documents WO9927291A1 and DE9217629U1 describe quick-connection devices that comprise a safety system which prevents disconnection when the device is pressurized.

The document WO2012004483A1 describes notably a safety device which prevents mechanical disconnection between a filling fitting and a filling connector when the filling fitting is pressurized.

Although satisfactory, the known solutions provide only an imperfect solution to the needs and developments in the ways users use interchangeable modular devices for supplying fluid.

An aim of the present invention is to remedy all or some of the drawbacks of the prior art that are set out above.

To this end, the device according to the invention, which is otherwise in accordance with the generic definition given in the preamble above, is essentially characterized in that the stop is able to move between a first position not locking the coupling members in order that they can be disconnected, and a second position locking the coupling members in order to prevent them from being disconnected, and in that the device comprises a return member that urges the stop into its first position.

Furthermore, embodiments of the invention can include one or more of the following features:

the stop comprises a pin that is able to move in translation between the first and second positions,

the stop comprises a pin that is able to move in a housing between the first and second positions, said housing comprising a first end that leads into or is fluidically connected to at least one of the internal circuits,

the device comprises a seal interposed between the first end of the housing and the stop in order to prevent fluidic communication between the internal circuit(s) and a second end of the housing, said second end of the housing housing an end of the stop that is intended to form a mechanical stop pin for the coupling members when said stop is in its second position,

at least one of the transfer member and said valve comprises a locking member for mechanically locking at least one of the coupling members, the locking member being movable and manually actuable between an active position in which it prevents the relative movement of the coupling members so as to prevent the transfer member from being detached from the first valve and an inactive position in which it allows the relative movement of the coupling members in order to allow the transfer member to be detached from the first valve, in its first position, the stop not interfering with said locking member and, in its second position, the stop mechanically locking the locking member and preventing it from moving from its active position to its inactive position,

the locking member comprises a tubular sleeve that is able to move in translation along a longitudinal axis parallel to its generatrices, and the stop is movable inside the sleeve, transversely with respect to the longitudinal axis,

the internal circuit of the transfer member comprises a shaft that is able to move in translation and forms a shutter driver that is intended to open the at least one isolation shutter of the first valve by mechanical actuation,

the first end of the housing of the stop leads into a portion of the internal transfer circuit of the transfer member comprising the movable shaft,

the valve comprises a connection end of cylindrical overall shape, and the coupling members comprise, for the one part, at least one groove and/or at least one rib formed on the outer surface of the connection end of the valve and, for the other part, at least one coupling element mounted on the transfer member so as to be movable between a position referred to as a “spaced-apart” position, allowing the introduction of the connection end of the valve into a central space of the transfer member, and a position referred to as a “moved-together” position, allowing the at least one coupling element to be coupled to the outer face of the connection end of the first valve,

the at least one coupling element comprises at least one of a system of movable claw(s) and a system of retractable pin(s) or ball(s),

the at least one coupling element comprises at least one movable claw that is disposed around a central space intended to accommodate the connection end of the valve, an internal face of the at least one claw that is situated facing the central space being provided with reliefs and/or recesses and being movable transversely with respect to the central space,

the locking member is mounted on the transfer member, the locking member being movable with respect to the coupling element(s) between its active position locking the at least one coupling element in the moved-together position and its inactive position allowing the movement of the at least one coupling element into the spaced-apart position,

the locking member is urged into its active position by default by a return member,

the transfer member comprises at least one of a second valve and a filling fitting provided for filling fluid into and/or extracting fluid from the tank via the first valve,

the transfer member comprises several claws that are spaced apart from one another around a central longitudinal axis,

the locking member is disposed about the at least one coupling element,

the locking member is in the form of a sleeve and is able to move in translation in a direction parallel to the longitudinal axis,

when the at least one coupling element is in the spaced-apart position, a stop prevents the locking member from passing from the inactive position to the active position, and when the at least one coupling element is in the moved-together position, the passage of the locking member from the inactive position to the active position is not impeded by the stop,

the device comprises a movable member for selectively spacing apart the claws, said spacing-apart member being movable between a position referred to as a “working” position, preventing the claws from moving from the spaced-apart position to the moved-together position, and a position referred as a “rest” position, allowing the claws to move from the spaced-apart position to the moved-together position, the spacing-apart member preferably being urged into its working position by a return member.

The invention also relates to a fluid transfer member, notably a valve or filling fitting intended to be connected in a removable manner to a first valve mounted on a tank of pressurized fluid, the transfer member comprising a body that houses an internal circuit for transferring pressurized fluid, a shaft that is able to move in translation in the internal transfer circuit and forms a shutter driver that is intended to open the at least one isolation shutter of a first valve by mechanical actuation, the body of the transfer member comprising at least one coupling element mounted on the body of the transfer member so as to be movable between a position referred to as a “spaced-apart” position, allowing the introduction of the connection end of the valve into a central space of the transfer member, and a position referred to as a “moved-together” position, allowing the at least one coupling element to be coupled to the outer face of the connection end of a first valve, the transfer member comprising a stop that is sensitive to the pressure in the internal circuit in order to lock the coupling element in the moved-together position and thus to prevent its disconnection when said pressure is greater than a given threshold, the stop being able to move between a first position not locking the coupling element and a second position locking the coupling element, and the transfer member comprising a return member that urges the stop into its first position.

The invention can also relate to any alternative device or method comprising any combination of the features above or below.

### BRIEF DESCRIPTION OF THE DRAWINGS

Further particular features and advantages will become apparent from reading the following description, given with reference to the figures, in which:

FIG. 1 shows a schematic and partial view in cross section, illustrating an embodiment of a device for supplying fluid in a disconnected state,

FIG. 2 shows a schematic and partial view in cross section of the device for supplying fluid in FIG. 1 in a connected and non-locked state,

FIG. 3 shows a schematic and partial view in cross section of the device for supplying fluid in FIG. 1 in a connected and locked state,

FIG. 4 shows a schematic and partial view in longitudinal section, illustrating an example of the structure of a valve of a device for supplying fluid according to one exemplary embodiment of the invention,

FIG. 5 shows a schematic and partial view in longitudinal section of a first valve, to which the valve in FIG. 4 is connected, and in a non-locked state,

FIG. 6 shows a view similar to the one in FIG. 5 and enlarged, illustrating the device for supplying fluid in a locked state.

### DESCRIPTION OF PREFERRED EMBODIMENTS

The device for supplying pressurized fluid, notably pressurized gas, comprises a tank 2 of pressurized fluid provided with an orifice in which a first valve 3 is fixed.

The first valve 3 comprises an internal fluid circuit 4 comprising at least one isolation shutter 5 and preferably several shutters disposed in series.

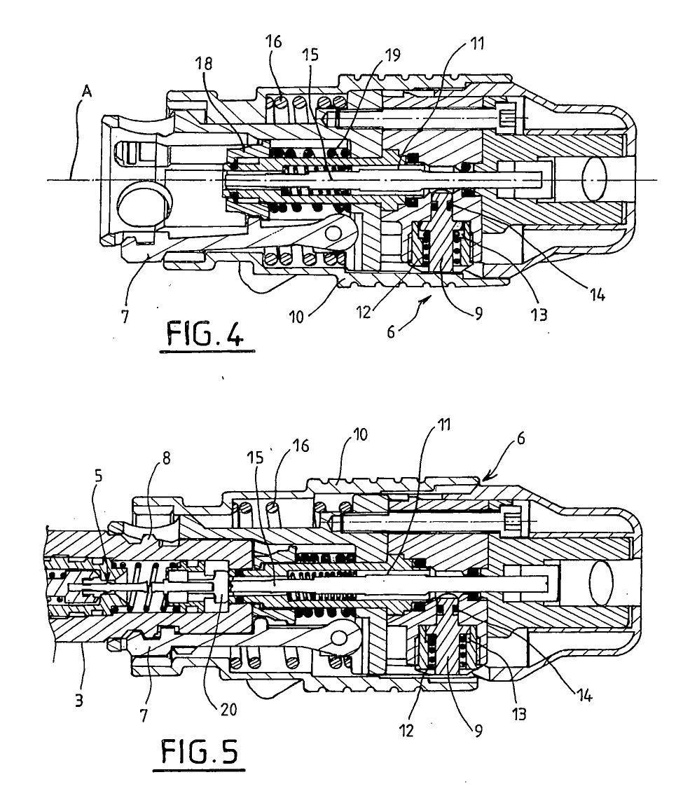

As illustrated in the example in FIG. 4, the first valve 3 can comprise a body of cylindrical overall shape that houses, in its internal circuit 4, a dust protection shutter 20 disposed in series with at least one isolation shutter 5.

The device comprises a gas transfer member 6 that forms a separate physical entity from the valve 3 and from the tank 2.

In the example shown, the transfer member 6 can be a second valve and/or a filling member (for filling fluid into and/or extracting it from the tank 2 via the first valve 3).

The second valve 6 comprises an internal circuit 11 for transferring pressurized fluid, having for example at least one of an isolation shutter 21, a pressure regulator, a flow regulator, a safety relief valve, a filter, etc.

The second valve 6 and the first valve 3 comprise respective mechanical coupling members 7, 8 that form a quick-connection system for removably connecting the second valve 6 to the first valve 3.

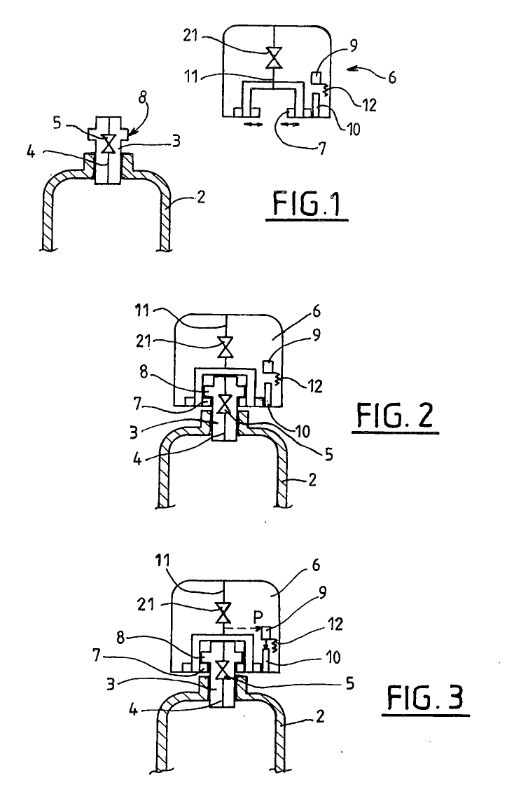

In the position in which the second valve 6 is connected to the first valve 3, the internal circuit 11 of the transfer member 6 is fluidically connected (in a leaktight manner via a system of seal(s)) to the internal circuit 4 of the first valve 3 (cf. FIGS. 2, 3, 5 and 6).

The device comprises a stop 9 that is sensitive to the pressure in at least one of the internal circuits 4, 11 in order to lock the coupling members 7, 8 in the connected position and to prevent the mechanical separation (disconnection) thereof when said pressure is greater than a given threshold.

According to one advantageous feature, the stop 9 is able to move between a first position not locking the coupling members 7, 8 in order that they can be disconnected, and a second position locking the coupling members 7, 8 in order to prevent them from being disconnected. Moreover, a return member 12 such as a spring urges the stop 9 into its first position.

In this way, in a situation without danger (no pressure within the internal circuit(s) 4, 11), the stop 9 does not impede free mechanical connection and disconnection of the two valves 3, 6.

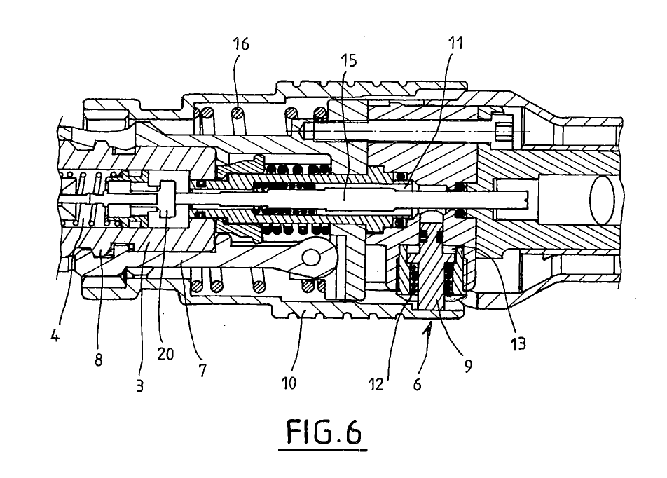

As illustrated schematically in FIGS. 1 to 3 and shown in FIGS. 4 to 6, the stop 9 can comprise a pin that is able to move in translation between its first (cf. FIGS. 1, 2, 4 and 5) and second positions (cf. FIGS. 3 and 6).

The stop 9 can notably comprise a pin that is able to move in a housing 13 (of the second valve 6) between the first and second positions. Said housing 13 comprises for example a first end that leads into or is fluidically connected to at least one of the internal circuits 4, 11 (cf. FIGS. 4 to 6).

As illustrated in FIGS. 4 to 6, the second valve 6 can have a seal 14 interposed between the first end of the housing 13 and the stop 9 in order to prevent fluidic communication between the internal circuit 11 and a second end of the housing 13.

The second end of the housing 13 houses an end of the stop 9 that is intended to form a stop pin for mechanically locking the coupling members 7, 8 when said stop 9 is in its second position. For example, the second end of the stop 9 protrudes from the housing in its second position (cf. FIG. 6).

As illustrated, the second valve 6 preferably comprises a locking member 10 for mechanically locking at least one of the coupling members 7, 8.

The locking member 10 comprises for example a tubular sleeve that is able to move in translation along a longitudinal axis A parallel to its generatrices on the body of the second valve 6. The stop 13 is notably advantageously movable inside the sleeve, transversely with respect to the longitudinal axis A (cf. FIG. 4).

This locking member 10 is movable and manually actuable between an active position in which it prevents the relative movement of the coupling members 7, 8 (cf. FIGS. 5 and 6) so as to prevent the second valve 6 from being detached from the first valve 3 and an inactive position (when the sleeve 10 has been moved to the right in FIGS. 4 to 6, in the direction in which it is spaced apart from the first valve 3) in which it allows the relative movement of the coupling members 7, 8 in order to allow the second valve 6 to be detached from the first valve 3.

In its first position, the stop 9 does not interfere with the locking member 10 (cf. FIG. 4 or 5). In its second position, the stop 9 mechanically locks the locking member 10 and prevents it from moving from its active position to its inactive position.

More specifically, when the internal circuit 11 of the second valve 6 is pressurized (transfer of fluid from or to the first valve), the pressure in the circuit exerts a force on the movable stop 9 in order to move it into its second position. When this pressure exceeds a given threshold, this force exceeds the force of the spring 12 and the stop 9 is moved so as to be positioned on the path of the sleeve 10 (for example protruding out of the passage 13).

In spite of the manual force applied by the user, the locking sleeve 10 then remains in its position in which it locks the coupling members 7, 8 and makes it impossible to disconnect them. Thus, the stop makes it possible to lock or not lock the coupling members 7, 8 indirectly (via the sleeve 10). Of course, in a variant, it is conceivable for the movable stop 9 to directly mechanically lock one of the coupling members 7, 8.

As illustrated in FIGS. 4 to 6, the internal circuit 11 of the second valve 6 can comprise a shaft 15 that is able to move in translation and forms a shutter driver that is intended to open the shutter(s) 20; 5 of the first valve 3 by mechanical actuation.

The shutter driver 15 is for example able to move in translation along its axis of longitudinal symmetry A (preferably coincident with a longitudinal central axis of the second valve 6).

The shutter driver 15 is for example moved manually or automatically via a lever and/or a remote control. The shutter driver 15 can push the dust protection shutter 20, which then in turn pushes the isolation shutter 4 out of its seat.

Preferably, and as illustrated, the first end of the housing 13 of the stop 9 leads into a portion of the internal transfer circuit 11 of the second valve 6 comprising the movable shaft 15.

According to one possible alternative, the movement of the stop 9 into its second position (or first position) is linked to the position of the shutter driver 15 (via a mechanical or automatic coupling for example). For example, when the shutter driver 15 is in a position corresponding to a valve opening (protruding), the stop 9 is moved automatically into its second, locking position.

In non-limiting examples shown in the figures, the valve 3 comprises a connection end of cylindrical overall shape.

Moreover, the coupling members 7, 8 comprise, for the one part, at least one groove and/or at least one rib 8 formed on the outer surface of the connection end of the valve 3 and, for the other part, at least one coupling element 7 mounted on the second valve 6 so as to be movable between a position referred to as a “spaced-apart” position, allowing the introduction of the connection end of the valve 3 into a central space of the second valve 6, and a position referred to as a “moved-together” position, allowing the at least one coupling element 7 to be coupled to the outer face of the connection end of the first valve 3.

In the example in FIGS. 4 to 6, the at least one coupling element 7 comprises a system of movable claws 7.

The claws 7 are movable on the second valve 6 about a central space intended to accommodate the connection end of the valve 3. The internal face of the claws 7 that is situated facing the central space is provided with reliefs 12 and/or recesses 22 that are complementary to the outer surface of the first valve 3.

The claws 7 are movable transversely with respect to the central space.

The locking sleeve 10 is mounted on the second valve 6 and is movable with respect to the coupling claws 7 between its active position locking the claws 7 in the moved-together position (FIGS. 5 and 6) and its inactive position allowing the claws 7 to move (apart) into the spaced-apart position.

The locking sleeve 10 is preferably urged into its active position by default by a return member 16 such as a spring (cf. FIGS. 4 to 6).

Similarly, when the claws 7 are in the spaced-apart position, a stop 17 borne by the claws 7 can prevent the locking sleeve 10 from passing from the inactive position to the active position. By contrast, when the claws 7 are in the moved-together position, the passage of the locking sleeve 10 from the inactive position to the active position is not impeded by the stop 17.

The second valve 6 can also comprise a movable member 18 for selectively spacing apart the claws 7. The spacing-apart member 18 is movable between a position referred to as a “working” position, preventing the claws 7 from moving from the spaced-apart position to the moved-together position (FIG. 4), and a position referred as a “rest” position, allowing the claws 7 to move from the spaced-apart position to the moved-together position (FIGS. 5 and 6). The spacing-apart member 18 is preferably urged into its working position by a return member 19 such as a spring and can be pushed into its rest position by the end of the first valve 3 during connection to the second valve 6.

Of course, the quick-connection system with claws can be replaced by any other appropriate equivalent system, for example a system of retractable pin(s) or ball(s) disposed on the second valve 6 that is snap-fastened to the first valve 3.

Thus, while having a simple structure and being inexpensive, the invention makes it possible to secure the connection of modules for transferring pressurized fluid without increasing the bulk thereof and without impairing their ergonomics.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-14. (canceled)

15. A device for supplying pressurized fluid, comprising a tank of pressurized fluid provided with an orifice in which a first valve is fixed that houses an internal fluid circuit provided with at least one isolation shutter, the device comprising a fluid transfer member that forms a separate physical entity from the valve and from the tank, the transfer member comprising an internal circuit for transferring pressurized fluid, the transfer member and said first valve comprising respective coupling members that form a quick-connection system for removably connecting the transfer member to the valve, in the position in which the transfer member is connected to the first valve, the internal circuit of the transfer member being fluidically connected to the internal circuit of the first valve, the device comprising a stop that is sensitive to the pressure in at least one of the internal circuits in order to lock the coupling members in the connected position and to prevent the disconnection of the transfer member from the first valve when said pressure is greater than a given threshold, wherein the stop is configured to move between a first position not locking the coupling members in order to be disconnected, and a second position locking the coupling members in order to prevent disconnection, and in that the device comprises a return member that urges the stop into a first position, and in that the stop comprises a pin that is able to move in a housing between the first and second positions, said housing comprising a first end that leads into or is fluidically connected to at least one of the internal circuits, and in that the internal circuit of the transfer member comprises a shaft that is configured to move in translation and forms a shutter driver that is configured to open the at least one isolation shutter of the first valve by mechanical actuation, the first end of the housing of the stop leading into a portion of the internal transfer circuit of the transfer member comprising the movable shaft.

16. The device according to claim 15, wherein the stop further comprises a pin that is able to move in translation between the first and second positions.

17. The device according to claim 15, further comprising a seal interposed between the first end of the housing and the stop in order to prevent fluidic communication between the internal circuit(s) and a second end of the housing, said second end of the housing an end of the stop that is configured to form a mechanical stop pin for the coupling members when said stop is in the second position.

18. The device according to claim 15, wherein at least one of the transfer member and said valve comprises a locking member for mechanically locking at least one of the coupling members, the locking member being movable and manually actuable between an active position in which it prevents the relative movement of the coupling members so as to prevent the transfer member from being detached from the first valve and an inactive position in which it allows the relative movement of the coupling members in order to allow the transfer member to be detached from the first valve, and wherein, in the first position, the stop does not interfere with said locking member and, in the second position, the stop mechanically locks the locking member and prevents it from moving from its active position to its inactive position.

19. The device according to claim 18, wherein the locking member comprises a tubular sleeve that is configured to move in translation along a longitudinal axis (A) parallel to the generatrices, and in that the stop is movable inside the sleeve, transversely with respect to the longitudinal axis (A).

20. The device according to claim 15, further comprising a connection end of cylindrical overall shape, and wherein the coupling members comprise, at least one groove and/or at least one rib formed on the outer surface of the connection end of the valve and, at least one coupling element mounted on the transfer member so as to be movable between a position referred to as a “spaced-apart” position, allowing the introduction of the connection end of the valve into a central space of the transfer member, and a position referred to as a “moved-together” position, allowing the at least one coupling element to be coupled to the outer face of the connection end of the first valve.

21. The device according to claim 20, wherein the at least one coupling element comprises at least one of a system of movable claw(s) and a system of retractable pin(s) or ball(s).

22. The device according to claim 21, wherein that the at least one coupling element comprises at least one movable claw that is disposed around a central space configured to accommodate the connection end of the valve, an internal face of the at least one claw that is situated facing the central space being provided with reliefs and/or recesses and being movable transversely with respect to the central space.

23. The device according to claim 18, wherein the locking member is urged into the active position by default by a return member.

24. The device according to claim 15, wherein the transfer member comprises at least one of a second valve and a filling fitting provided for filling fluid into and/or extracting fluid from the tank via the first valve.

25. The device according to claim 15, wherein when the at least one coupling element is in the spaced-apart position, a stop prevents the locking member from passing from the inactive position to the active position, and when the at least one coupling element is in the moved-together position, the passage of the locking member from the inactive position to the active position is not impeded by the stop.

26. The device according to claim 15, further comprising a movable member for selectively spacing apart the claws, said spacing-apart member being movable between a position referred to as a “working” position, preventing the claws from moving from the spaced-apart position to the moved-together position, and a position referred as a “rest” position, allowing the claws to move from the spaced-apart position to the moved-together position, the spacing-apart member preferably being urged into its working position by a return member.

27. A fluid transfer member, configured to be connected in a removable manner to a first valve mounted on a tank of pressurized fluid, the transfer member comprising a body that houses an internal circuit for transferring pressurized fluid, a shaft that is configured to move in translation in the internal transfer circuit and forms a shutter driver that is configured to open the at least one isolation shutter of a first valve by mechanical actuation, the body of the transfer member comprising at least one coupling element mounted on the body of the transfer member so as to be movable between a position referred to as a “spaced-apart” position, allowing the introduction of the connection end of the valve into a central space of the transfer member, and a position referred to as a “moved-together” position, allowing the at least one coupling element to be coupled to the outer face of the connection end of a first valve, the transfer member comprising a stop that is sensitive to the pressure in the internal circuit in order to lock the coupling element in the moved-together position and thus to prevent disconnection when said pressure is greater than a given threshold, wherein the stop is configured to move between a first position not locking the coupling element and a second position locking the coupling element, and in that the transfer member comprises a return member that urges the stop into the first position.
